(19) United States
(12) Patent Application Publication
(10) Pub. No.: US 2014/0189407 A1
(43) Pub. Date: Jul. 3, 2014

(54) DATA STORAGE DEVICE AND METHOD FOR OPERATING THE SAME

(71) Applicant: SK hynix Inc., Gyeonggi-do (KR)

(72) Inventors: Eu Joon BYUN, Gyeonggi-do (KR); Kyeong Rho KIM, Gyeonggi-do (KR); Se Chun PARK, Seoul (KR)

(73) Assignee: SK hynix Inc., Gyeonggi-do (KR)

(21) Appl. No.: 14/103,537

(22) Filed: Dec. 11, 2013

(30) Foreign Application Priority Data
Jan. 3, 2013 (KR) 10-2013-0000687

(51) Int. Cl. G06F 1/32

(52) U.S. Cl. CPC G06F 1/3212
USPC 713/323

(57) ABSTRACT

A data storage device and a method for operating the same are provided. In the data storage device and the method for operating the same, a predetermined number of memory chips are operated based on a usable power limitation when a power supply is supplied from a finite power supply source such as a battery, and as many memory chips as possible are operated in parallel. Accordingly, performance of the data storage device may be improved.

### CROSS-REFERENCE TO RELATED APPLICATION

The present application claims priority to Korean patent application number 10-2013-0000687 filed on Jan. 3, 2013, in the Korean Intellectual Property Office, the entire disclosure of which is incorporated herein by reference.

### BACKGROUND

1. Technical Field

Various embodiments of the present invention relate to an electronic apparatus. More specifically, the present invention relates to a data storage device and a method for operating the same.

2. Related Art

Semiconductor memory devices among data storage devices are generally classified as volatile memory devices and non-volatile memory devices.

A volatile memory device has high write and read speeds, but when a power supply is cut off, stored data disappears. A non-volatile memory device has relatively low write and read speeds, but stored data retained even when the power supply is cut off. Accordingly, the non-volatile memory device is used to retain the stored data. The non-volatile memory device includes a read-only memory (ROM), a mask ROM (MROM), a programmable ROM (PROM), an erasable programmable ROM (EPROM), an electrically erasable programmable ROM (EEPROM), a flash memory, a phase-change RAM (PRAM), a magnetic RAM (MRAM), a resistive RAM (RRAM), a ferroelectric RAM (FRAM), or the like. Flash memories are classified as a NOR type and a NAND type.

Rash memories have an advantage of a RAM in that programming and erasure of data are free, and an advantage of the ROM in that stored data is retained even when the power supply is cut off. The flash memories have low power consumption, fast data access performance and a small size con pared with a conventional disk, such as a hard disk. Furthermore, the flash memories have an advantage of having strong physical shock-resistance and a low weight. The flash memories are widely used as a storage medium of portable electronic apparatuses such as a digital camera, a personal digital assistant (PDA), an MP3 player, or the like.

Since the portable electronic apparatus such as a smart phone uses a battery with a limited capacity, it is necessary for the portable electronic apparatus to manage and use power efficiently. Accordingly, since a power supply or management unit in the portable electronic apparatus limits usable maximum power, the operating performance and duration of operation of the portable electronic apparatus are limited.

### BRIEF SUMMARY

The present invention is directed to a data storage device and a method for operating the same that is capable of improving operating performance.

An embodiment according to the present invention provides a data storage device, including a plurality of memory chips connected in parallel with each other, a memory controller suitable for controlling the plurality of memory chips, and a power supply controller suitable for generating a control signal based on power supplied from a finite power supply source or an infinite power supply source, wherein the memory controller controls the number of memory chips operating in parallel in response to the control signal.

The memory controller may control the memory chips to allow a first number of the memory chips to operate in parallel in response to a first control signal generated based on the power supplied from the finite power supply source, and may control the memory chips to allow a second number of the memory chips to operate in parallel in response to a second control signal generated based on the power supplied from the infinite power supply source, wherein the second number may be larger than the first number.

The memory controller may control the memory chips to allow all the memory chips to operate in parallel in response to the second control signal.

The memory controller may determine the first number based on a usable power limitation.

The power supply controller may include a power supply unit suitable for supplying an operating voltage to the memory chips based on the power supplied from the finite power supply source or the infinite power supply source, and a controller suitable for generating the control signal based on the power supply.

The infinite power supply source may include an AC adaptor or a USB.

The finite power supply source may include a battery.

Another embodiment of the present invention provides a data storage device, including a plurality of memory chips connected in parallel, and a memory controller suitable for controlling an operation of the memory chips, and controlling the number of memory chips operating in parallel based on power supplied from a finite power supply source or an infinite power supply source.

The memory controller may control the memory chips to allow a first number of the memory chips to operate in parallel based on the power supplied from the finite power supply source, and control the memory chips to allow a second number of the memory chips to operate in parallel based on the power supplied from the infinite power supply source, wherein the second number may be larger than the first number.

Still another embodiment of the present invention provides a method for operating a data storage device, including detecting whether a power supply is supplied from a finite power supply source or an infinite power supply source, and controlling a first number of memory chips among a plurality of memory chips to operate in parallel when the power supply is supplied from the finite power supply source, and controlling a second number, which may be larger than the first number, of the memory chips to operate in parallel when the power supply is supplied from the infinite power supply source.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram illustrating a data storage device according to an exemplary embodiment of the present invention;

FIG. 2 is a circuit diagram illustrating a power supply controller shown in FIG. 1 according to an embodiment of the present invention;

FIG. 3 is a block diagram illustrating a data storage device according to another exemplary embodiment of the present invention;

FIG. 4 is a flowchart illustrating a method for operating a data storage device according to an exemplary embodiment of the present invention; and

FIG. 5 is a flowchart illustrating a method for operating a data storage device according to another exemplary embodiment of the present invention.

### DETAILED DESCRIPTION

The present invention will be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

It is also noted that in this specification, “connected/coupled” refers to one component not only directly coupling another component but also indirectly coupling another component through an intermediate component. In addition, a singular form may include a plural form as long as it is not specifically mentioned in a sentence.

Unlike a hard disk, in flash memories, a corresponding sector has to be emptied to perform a write operation on a specific sector. That is, an overwrite operation is not allowed on a sector in which data is written. Accordingly, the write operation has to be performed after performing an erase operation that erases a whole block including the sector. However, the erase operation of the block requires more time than the write operation and a read operation. The characteristics of the flash memories make it difficult to substitute the flash memories for the conventional hard disk and may degrade overall performance of a flash memory system.

To resolve the issues of utilizing flash memories, system software, such as a flash translation layer (FTL), is used. The FTL is located between a flash memory and a file system, and the file system causes the flash memory to be used as a block device such as a hard disk. Using the FTL, the file system used in the conventional hard disk may be used without an additional file system. Additionally, the FTL may be included in a storage device regardless of a memory controller. The FTL may also be included in the memory controller.

The file system transmits a write request in units of sectors. However, in the flash memory, more specifically, a NAND flash memory, a minimum unit of a write operation may be a page. The FTL converts a logical address into a physical address through a mapping table.

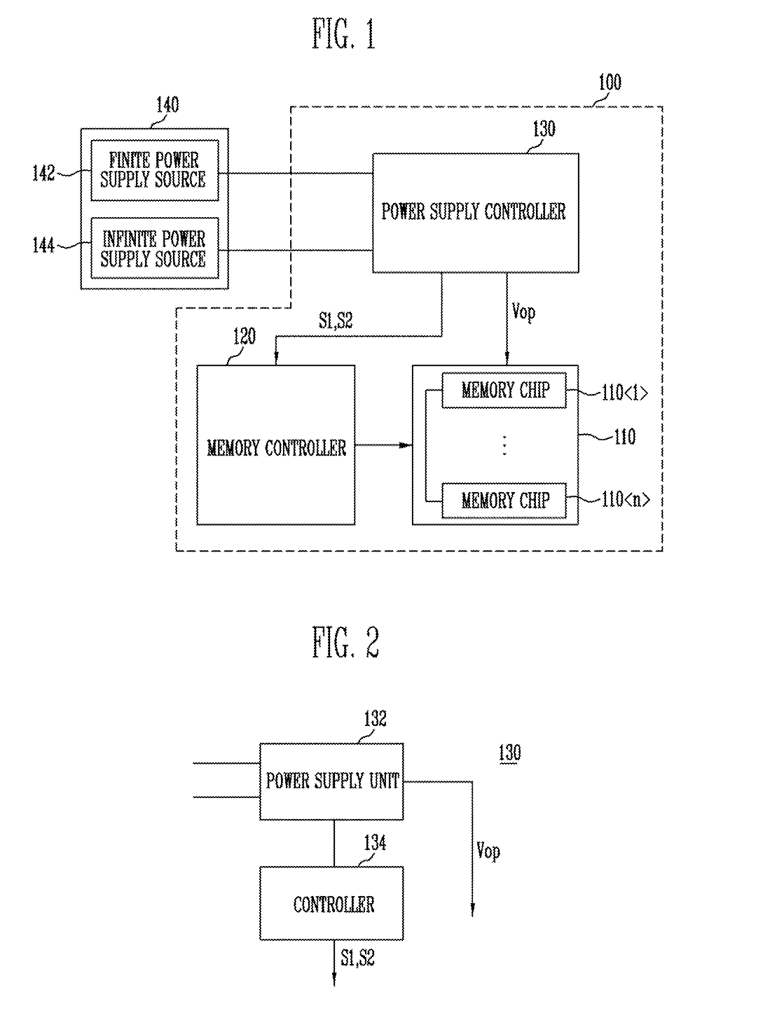

FIG. 1 is a block diagram illustrating a data storage device according to an exemplary embodiment of the present invention.

Referring to FIG. 1, the data storage device 100 includes a plurality of memory chips 110, a memory controller 120, and a power supply controller 130.

The data storage device 100 may include n memory chips 110<1> to 110<n>.

The memory chips 110<1> to 110<n> may be connected in parallel.

The memory controller 120 may control an operation of the memory chips 110<1> to 110<n>.

The power supply controller 130 receives a power supply from a power supply source 140. The power supply controller 130 supplies an operating voltage Vop to the memory chips 110<1> to 110<n>.

The power supply controller 130 generates control signals S1 and S2 based on power supplied from a finite power supply source 142 or an infinite power supply source 144.

The power supply controller 130 generates the first control signal S1 based on power supplied from the finite power supply source 142, and generates the second signal S2 based on power supplied from the infinite power supply source 144.

The power supply controller 130 may also generate the second control signal S2 based on the power supplied from the finite power supply source 142 and the infinite power supply source 144.

The memory controller 120 controls the number of memory chips 110<1> to 110<n> operating in parallel in response to the control signals S1 and S2.

The memory controller 120 controls the memory chips 110<1> to 110<n> to allow a first number of the memory chips to operate in parallel in response to the first control signal S1.

The memory controller 120 controls the memory chips 110<1> to 110<n> to allow a second number, which is greater than the first number, of the memory chips to operate in parallel in response to the second control signal S2.

The memory controller 120 controls the memory chips 110<1> to 110<n> to allow all the memory chips 110<1> to 110<n> to operate in parallel in response to the second control signal S2.

The memory controller 120 determines the first number based on a usable power limitation.

The infinite power supply source 142 includes an AC adaptor or a universal serial bus (USB).

The finite power supply source 144 includes a battery.

When the number of memory chips operated in parallel increases, performance of the data storage device 100 is increased, however much more power is used. Due to the usable power limitation, the number of memory chips operated in parallel is limited. The data storage device 100 according to an embodiment of the present invention operates a predetermined number of memory chips in parallel based on the usable power limitation when a power supply is supplied from the finite power supply source 142 such as a battery, and operates as many memory chips as possible in parallel when the power supply is supplied from the infinite power supply source 144. Accordingly, performance of the data storage device 100 may be improved.

FIG. 2 is a circuit diagram for illustrating a power supply controller shown in FIG. 1 according to an embodiment of the present invention.

Referring to FIG. 2, the power supply controller 130 includes a power supply unit 132 and a controller 134.

The power supply unit 132 supplies an operating voltage Vop based on power supplied from the finite power supply source 142 or the infinite power supply source 144.

The controller 134 generates the control signals S1 and S2 based on the power supply.

The controller 134 generates the first control signal S1 based on the power supplied from the finite power supply source 142, and generates the second control signal S2 based on the power supplied from the infinite power supply source 144. The controller 134 may generate the second control signal S2 based on the power supplied from the finite power supply source 142 and the infinite power supply source 144.

FIG. 3 is a block diagram illustrating a data storage device according to another exemplary embodiment of the present invention.

Referring to FIG. 3, the data storage device 200 includes a plurality of memory chips 210 and a memory controller 220.

The data storage device 200 may include n memory chips 210<1> to 210<n>.

The memory chips 210<1> to 210<n> are connected in parallel.

The memory controller 220 controls an operation of the memory chips 210<1> to 210<n> and controls the number of memory chips operating in parallel based on power supplied from a finite power supply source 142 or an infinite power supply source 144.

The memory controller 220 controls the memory chips 210<1> to 210<n> to allow the first number of memory chips to operate in parallel based on the power supplied from the finite power supply source 142.

The memory controller 220 controls the memory chips 210<1> to 210<n> to allow the second number, which is larger than the first number, of memory chips to operate in parallel based on the power supplied from the infinite power supply source 144.

The memory controller 220 controls the memory chips 210<1> to 210<n> to allow all the memory chips 210<1> to 210<n> to operate in parallel based on the power supplied from the infinite power supply source 144.

The memory controller 220 determines the first number based on a usable power limitation.

The infinite power supply source 142 includes an AC adaptor or a USB.

The finite power supply source 144 includes a battery.

In the data storage device 200 shown in FIG. 3, the memory controller 220 also performs the function of the power supply controller shown in FIG. 1.

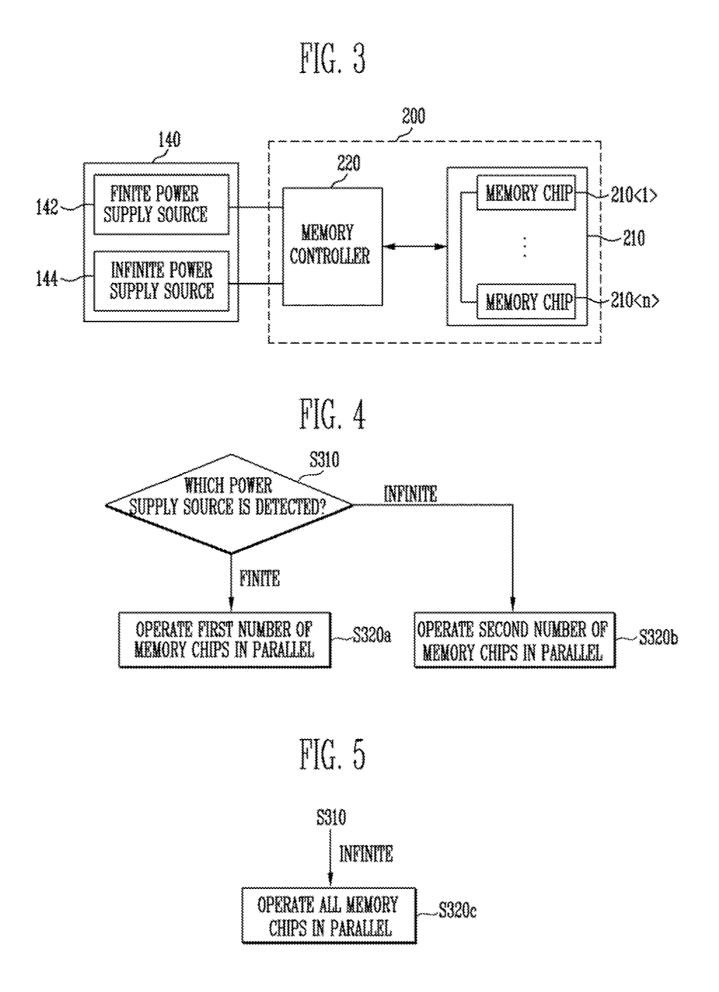

FIG. 4 is a flowchart for illustrating a method for operating a data storage device according to an exemplary embodiment of the present invention.

Referring to FIG. 4 a method for operating the data storage device includes detecting whether a power supply is supplied from a finite power supply source or an infinite power supply source (S310).

The method includes controlling memory chips to allow the first number of memory chips among the memory chips to operate in parallel when the power supply is supplied from the finite power supply source (S320a).

The method includes controlling the memory chips to allow the second number, which is larger than the first number, of memory chips to operate in parallel when the power supply is supplied from the infinite power supply source (S320b).

The first number is determined based on a usable power limitation.

The infinite power supply source includes an AC adaptor or a USB.

The finite power supply source includes a battery.

FIG. 5 is a flowchart illustrating a method for operating a data storage device according to another exemplary embodiment of the present invention.

Referring to FIG. 5, after the detecting of whether the power supply is supplied from the finite power supply source or the infinite power supply source (S310), the method includes controlling the memory chips to allow all the memory chips to operate in parallel when the power supply is supplied from the infinite power supply source (S320c).

The method for operating the data storage device according to an embodiment of the present invention includes operating the predetermined number of memory chips based on the usable power limitation when the power supply is supplied from the finite power supply source such as a battery, and operating as many memory chips as possible in parallel. Accordingly, performance of the data storage device may be improved.

In the data storage device and the method for operating the same according to embodiments of the present invention, the predetermined number of memory chips are operated based on the usable power limitation when the power supply is supplied from the finite power supply source such as a battery, and as many memory chips as possible are operated in parallel. Accordingly, performance of the data storage device may be improved. In the drawings and specification, there have been disclosed typical exemplary embodiments of the invention, and although specific terms are employed, they are used in a generic and descriptive sense only and not for purposes of limitation. As for the scope of the invention, it is set forth in the following claims. Therefore, it will be understood by those of ordinary skill in the art that various changes in form and details may be made therein without departing from the spirit and scope of the present invention as defined by the following claims.

What is claimed is:

1. A data storage device, comprising:
a plurality of memory chips connected in parallel with each other;
a memory controller suitable for controlling the plurality of memory chips; and
a power supply controller suitable for generating a control signal based on power supplied from a finite power supply source or an infinite power supply source, wherein the memory controller controls the number of memory chips operating in parallel in response to the control signal.

2. The data storage device of claim 1, wherein the memory controller controls the memory chips to allow a first number of the memory chips to operate in parallel in response to a first control signal generated based on the power supplied from the finite power supply source, and controls the memory chips to allow a second number of the memory chips to operate in parallel in response to a second control signal generated based on the power supplied from the infinite power supply source, wherein the second number is larger than the first number.

3. The data storage device of claim 2, wherein the memory controller controls the memory chips to allow all the memory chips to operate in parallel in response to the second control signal.

4. The data storage device of claim 2, wherein the memory controller determines the first number based on a usable power limitation.

5. The data storage device of claim 1, wherein the power supply controller comprises:
a power supply unit suitable for supplying an operating voltage to the memory chips based on the power supplied from the finite power supply source or the infinite power supply source; and
a controller suitable for generating the control signal based on the power supply.

6. The data storage device of claim 1, wherein the infinite power supply source includes an AC adaptor or a USB.

7. The data storage device of claim 1 wherein the finite power supply source includes a battery.

8. A data storage device, comprising:
a plurality of memory chips connected in parallel; and
a memory controller suitable for controlling an operation of the memory chips, and controlling the number of memory chips operating in parallel based on power supplied from a finite power supply source or an infinite power supply source.

9. The data storage device of claim 8, wherein the memory controller controls the memory chips to allow a first number of the memory chips to operate in parallel based on the power supplied from the finite power supply source, and controls the memory chips to allow a second number of the memory chips to operate in parallel based on the power supplied from the infinite power supply source, wherein the second number is larger than the first number.

10. The data storage device of claim 9, wherein the memory controller controls the memory chips to allow all the memory chips to operate in parallel in response to the power supplied from the infinite power supply source.

11. The data storage device of claim 9, wherein the memory controller determines the first number based on a usable power limitation.

12. The data storage device of claim 8, wherein the infinite power supply source includes an AC adaptor or a USB.

13. The data storage device of claim 8, wherein the finite power supply source includes a battery.

14. A method for operating a data storage device, comprising:
detecting whether a power supply is supplied from a finite power supply source or an infinite power supply source; and
controlling a first number of memory chips among a plurality of memory chips to operate in parallel when the power supply is supplied from the finite power supply source, and controlling a second number, which is larger than the first number, of the memory chips to operate in parallel when the power supply is supplied from the infinite power supply source.

15. The method of claim 14, wherein all the memory chips operate in parallel when the power supply is supplied from the infinite power supply source.

16. The method of claim 14, wherein the first number is determined based on a usable power limitation.

17. The method of claim 14, wherein the infinite power supply source includes an AC adaptor or a USB.

18. The method of claim 14, wherein the finite power supply source includes a battery.
